(19) United States
(12) Patent Application Publication
(10) Pub. No.: US 2007/0180481 A1
(43) Pub. Date: Aug. 2, 2007

(54) Enhanced model of relation with quantitative representation, and tv anytime service method and system employing the same

(76) Inventors: Hee-Kyung Lee, Daejon (KR); Jae-Gon Kim, Daejon (KR); Jung-Won Kang, Seoul (KR); Jin-Soo Choi, Daejon (KR); Jin-Woong Kim, Daejon (KR)

Correspondence Address: LADAS & PARRY LLP, 224 SOUTH MICHIGAN AVENUE, SUITE 1600, CHICAGO, IL, 60604, US

(21) Appl. No.: 10/593,610

(22) PCT Filed: Dec. 17, 2004
(86) PCT No.: PCT/KR04/03346

§ 371 Date: Sep. 21, 2006

(30) Foreign Application Priority Data
Mar. 23, 2004 (KR) 10-2004-0019533
Jun. 24, 2004 (KR) 10-2004-0047611

(51) Int. Cl. H04N 7/173; H04N 5/445; G06F 13/00; H04N 7/16; G06F 3/00

(52) U.S. Cl. 725/102; 725/45; 725/52; 725/115; 725/145

(57) ABSTRACT

The present invention relates to a relation model, and more particular to an enhanced model of relation with a quantitative representation in a TV-Anytime service, a TV-Anytime service system employing the same and a TV-Anytime service method thereof. The TV-Anytime service system employing an enhanced quantitative representation uses a temporal relation metadata having a quantitative representation for describing a time order of consuming components and a spatial relation metadata for describing a related location of a user interface.

### TECHNICAL FIELD

The present invention relates to a model of relation;

and more particular, to an enhanced model of relation with quantitative representation, and a TV-anytime service system employing the same and a method thereof.

### BACKGROUND ART

Targeting and synchronization service, which is now under standardization progress in Calls For Contributions (CFC), which is TV-Anytime Phase 2 of Metadata Group, is similar to a personal program service which is appropriate for an environment that consumes user preference suggested conventionally and new types of contents including video, audio, image, text, Hypertext Markup Language (HTML) (refer to TV-Anytime contribution documents AN515 and AN525).

That is, the targeting and synchronization service automatically filters and delivers personalized content services properly to a terminal, a service environment, and user profile in consideration of synchronization between contents.

Hereinafter, the targeting and the synchronization service scenario will be explained in detail.

Each member of family consumes audio/video (AV) programs in their own ways in a home network environment connecting diverse media devices, such as Personal Digital Assistant (PDA), Moving Picture Experts Group (MPEG) Audio Layer 3 (MP3) player, Digital Versatile Disc (DVD) player and the like.

For example, the youngest sister who is an elementary school student likes to watch a sit-com program on a High-Definition (HD) TV. On the other hand, an elder sister who is a college student likes to watch a sit-com program with a Personal Digital Assistant (PDA) through multi-lingual audio stream to improve her language ability.

Such a contents consumption pattern is different according to each person and it depends on a variety of conditions such as terminals, networks, users, and types of contents.

Therefore, a targeting service is essentially required to a contents and service provider in the business of providing a personalized service properly to a service environment and user profile.

Also, the TV-Anytime phase 2 allows users to consume not only the simple audio/video for broadcasting but also diverse forms of contents including video, audio, moving picture, and application programs.

The different forms of contents can make up an independent content, but it is also possible to form a content with temporal, spatial and selectional relations between them. In the latter case, a synchronization service which describes the time point of each content consumption by describing the temporal relations between a plurality of contents is necessary to make a user consume the content equally with the other users or consume it in the form of a package consistently even though it is used several times.

There is an attempt to apply the MPEG-21 Digital Item Declaration (DID) structure to the embodiment of metadata for TV-Anytime targeting and synchronization service.

FIG. 1 is a diagram showing a schema of a conventional MPEG-21 DID.

The basic structure of the MPEG-21 DID can be used to embody package metadata for TV-Anytime targeting and synchronization service but the problem is that the DID elements of MPEG-21 are too comprehensive to be applied to the TV-Anytime service.

Therefore, it is required to embody package metadata that can supplement the DID elements more specifically in a TV-Anytime system to provide an effective targeting and synchronization service.

In order to identify packages and constitutional elements, the temporal and spatial formation of the constitutional elements and the relation between them should be specified.

### DISCLOSURE

### Technical Problem

It is, therefore, an object of the present invention to provide a method for concretely describing a relation between components/items for formation and synchronization between components and a TV-Anytime service system employing the same.

It is another object of the present invention to provide an enhanced model of a relation with a quantitative representation for formation and synchronization between components, a TV-Anytime service system employing the enhanced model and a TV-Anytime service method thereof.

### TECHNICAL SOLUTION

In accordance with one aspect of the present invention, there is provided a TV-Anytime service system employing an enhanced quantitative representation, including: a service providing device for generating a package metadata describing component relations with a quantitative representation; and a user terminal for consuming components according to analysis of the component relations with the quantitative representation in the generated package metadata.

In accordance with another aspect of the present invention, there is provided a TV-Anytime service method employing an enhanced model of relation with a quantitative representation, the TV-Anytime service method including the steps of: generating a package metadata describing component relations with a quantitative representation; analyzing the component relation with the quantitative representation by obtaining the package metadata; and consuming components according to analysis of the component relation with the quantitative representation.

### DESCRIPTION OF DRAWINGS

The above and other objects and features of the present invention will become apparent from the following description of the preferred embodiments given in conjunction with the accompanying drawings, in which:

FIG. 1 is a diagram showing a schema of a conventional MPEG-21 DID.

FIG. 2 shows binary temporal relations;

FIG. 3 describes n-ary temporal relations;

FIGS. 4A and 4B show definitions spatial relations relation (SpatialRelation CS);

FIG. 5 shows an example of a temporal relation having a quantitative representation;

FIG. 6 shows a spatial relation having a quantitative representation;

FIG. 7 shows a structure of relation metadata in accordance with a preferred embodiment of the present invention;

FIG. 8 show a relation metadata schema having a quantitative representation;

FIGS. 9A to 9F show learning package metadata for provided relation schema;

FIG. 10 is a diagram illustrating a TV-Anytime service system in accordance with a preferred embodiment; and

FIG. 11 is a flowchart showing a TV-Anytime service method in accordance with a preferred embodiment.

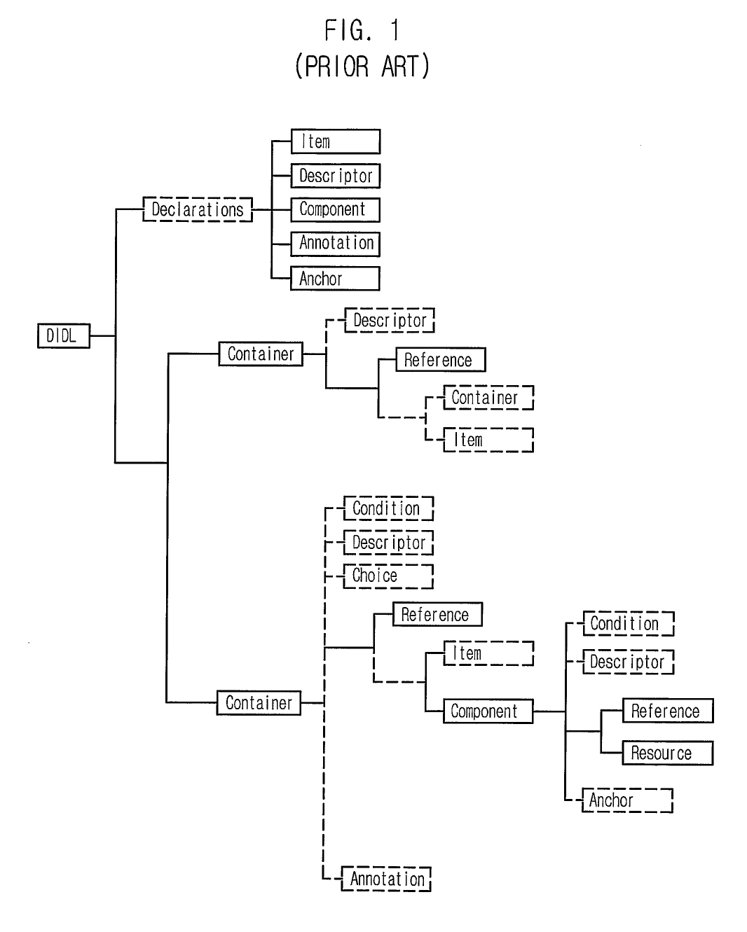

### BEST MODE FOR THE INVENTION

The above and other objects, features, and advantages of the present invention will become apparent from the following description and thereby one of ordinary skill in the art can embody the technological concept of the present invention easily. In addition, if further detailed description on the related prior art is determined to blur the point of the present invention, the description is omitted. Hereafter, preferred embodiments of the present invention will be described in detail with reference to the drawings. The terms or words used in the claims of the present specification should not be construed to be limited to conventional meanings and meanings in dictionaries and the inventor(s) can define a concept of a term appropriately to describe the invention in the best manner. Therefore, the terms and words should be construed in the meaning and concept that coincide with the technological concept of the present invention.

In claims of the present invention, constituent elements described as means for performing functions described in the present specification may include, for example, combinations of circuits for performing the functions or all methods including all types of software having a firmware/micro codes for performing the functions. Also, the constituent element may be coupled to an appropriate circuit for performing the software in order to perform the functions. Therefore, any means providing the functions should be understood to be equivalent to present embodiments represented in the present specification because the present invention defined by the claims includes combined functions provided from various described means and they are combined based on a method required by the claims.

In the present specification of the present invention, a term of “selection relation” is used as a term of “interaction relation”. Therefore, there are three terms such as a temporal relation, a spatial relation and a selection relation allowed for describing an interaction relation between components.

Hereinafter, a relation metadata will be explained at first and then a component relation model with a quantitative representation and a structure of a conscious package with enhanced relation description will be explained.

The relation metadata is information describing a relation between items or components for formation and synchronization between components.

In order to describe the relation metadata, the metadata relation between the component and the item will be explained at first.

Referring to classification schemes (CS), various relations between components can be described by using terms of a temporal, a spatial and an interaction in a component model. The components are also employed to items of a package. In the present embodiment, a selection relation is used as the interaction relation.

The relations between defined components, between items, and between components and items are used to represent how the components, items, or components and items are consumed in an abstract level rather than to represent precise synchronization which requires entire scene description such as SMIL, XMT-0 and BIFS simply by using terms pre-defined in the CS.

At first, a temporal relation (TemporalRelation CS) will be explained.

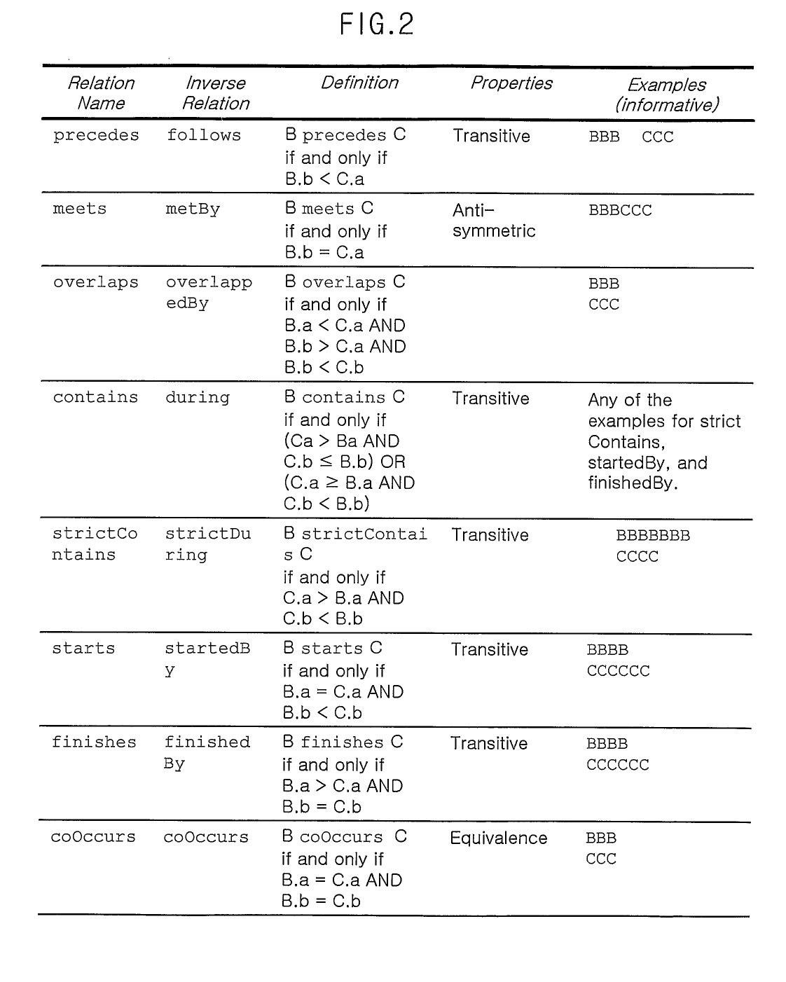

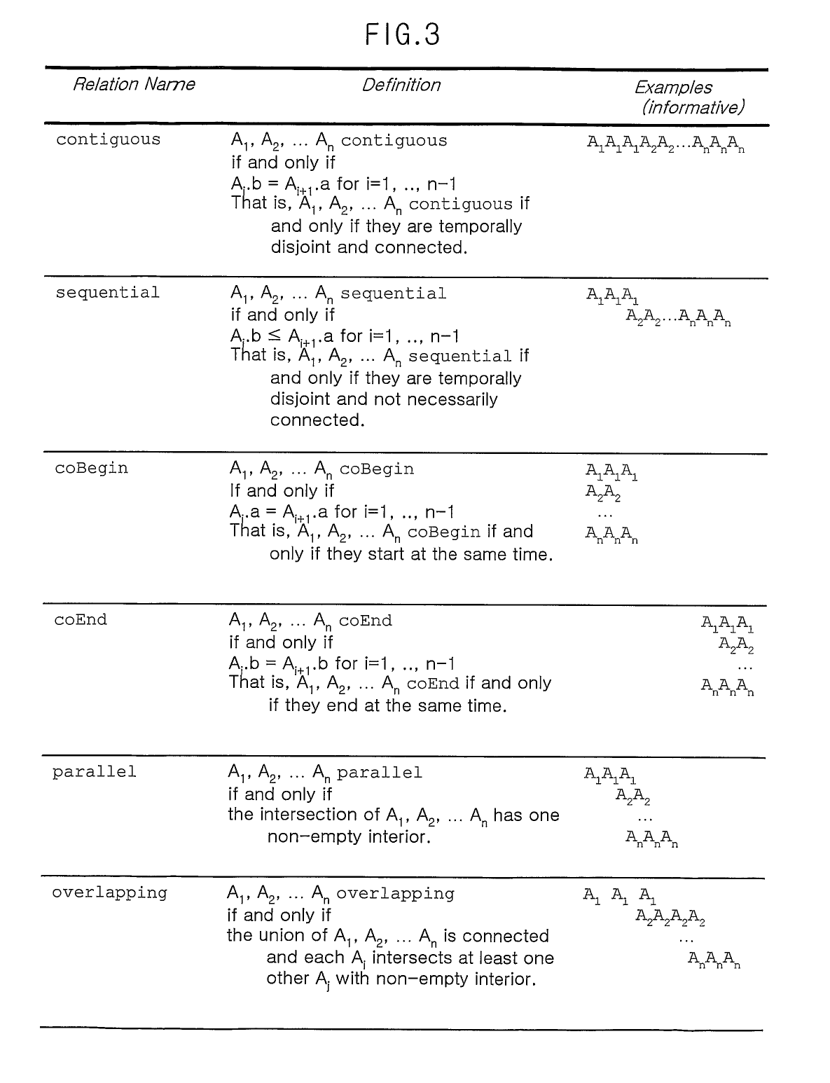

FIG. 2 is a table showing binary temporal relations and FIG. 3 is a table describing n-ary temporal relations. As shown in FIGS. 2 and 3, names of relations and names of inverse relations mathematically inversed from the relations are described in fields of “Relation Name” and “Inverse Relation”, respectively. Also, properties of corresponding relations and examples of using corresponding relations are described in fields of “Properties” and “Examples”, respectively.

A spatial relation (SpatialRelation CS) will be explained hereinafter.

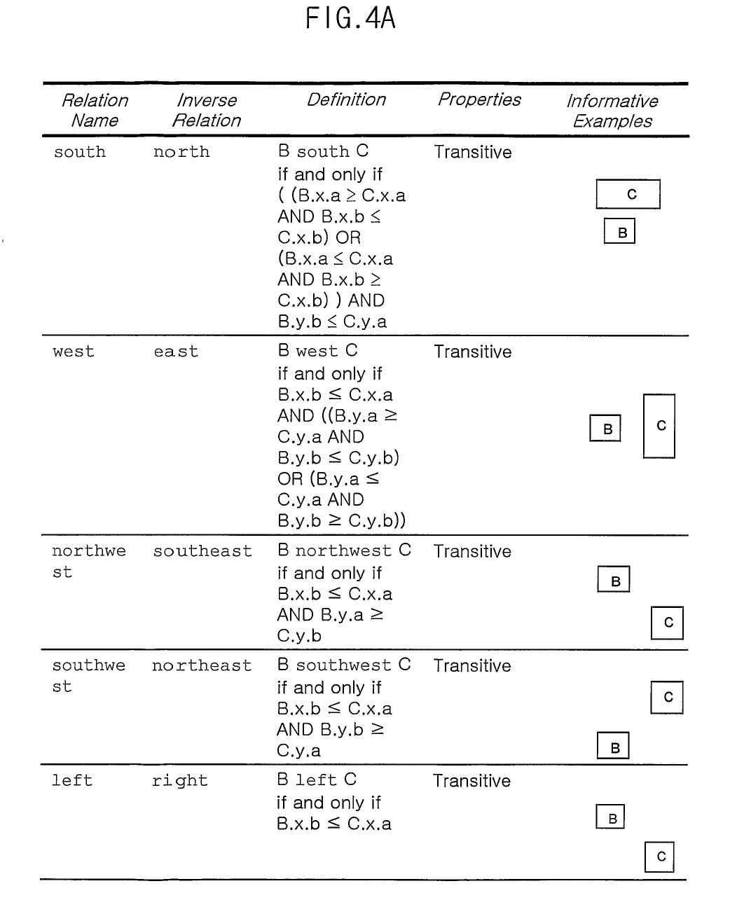

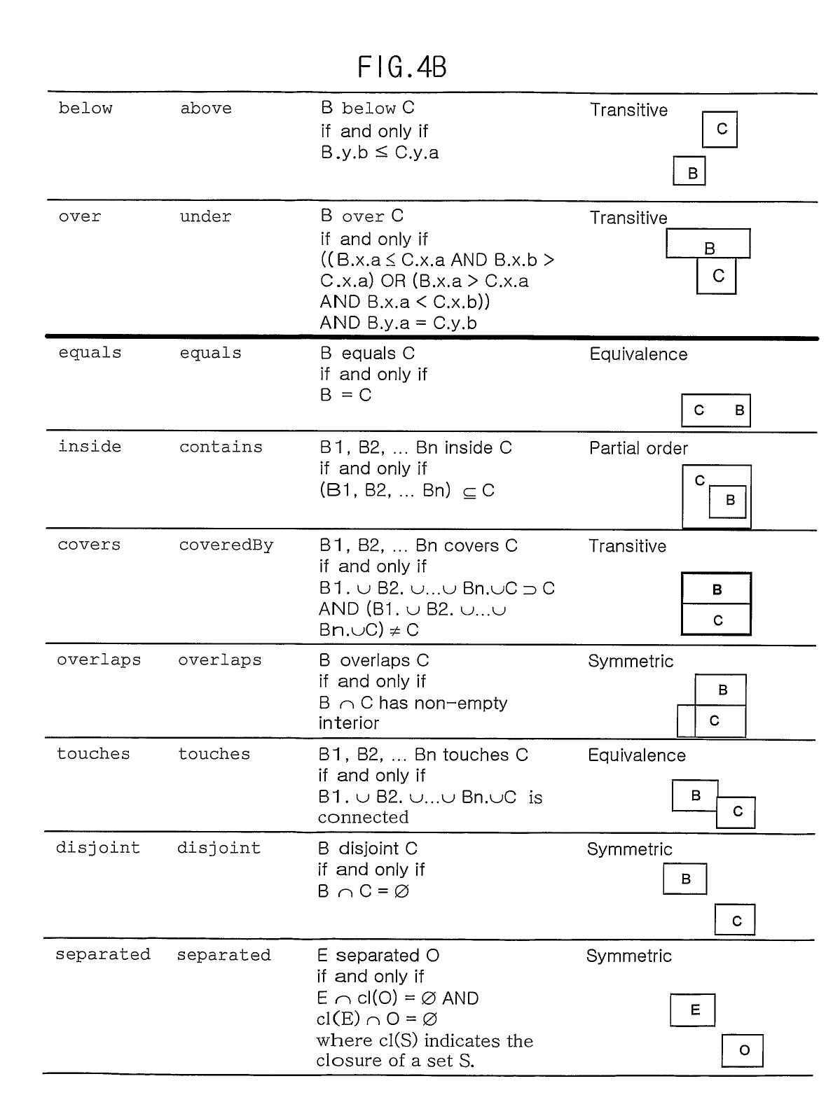

FIGS. 4A and 4B show definitions of spatial relations (spatialRelation CS).

In FIGS. 4A and 4B, names of relations and inverse relations are described in fields of “Relation Name” and “Inverse Relation”, respectively and mathematical definitions of corresponding relations are described in a field of “Definition”. Additionally, properties are described in the field of “Properties” and examples of corresponding relation are also described in the field of “Informative Examples”. Relations from “south” to “over” are based on a spatial relation. Relations from “equals” to “separated” are relations added in a base relation (BaseRelation). The spatial CS (SpatialCS) may be substituted by the spatial relation CS (SpatialRelation CS) in one-to-one manner and may be expanded by additional necessity.

<Enhancement of Relation Representation Having Quantitative Terms>

A. Necessity of Quantitative Representation

The relation metadata was explained as described above. The relation metadata allows describing a relative relation of three types, i.e., a temporal relation (TemporalRelation), a spatial relation (SpatialRelation) and a selectional relation (SelectionRelation) by referring to corresponding classification schemes between components (SCs).

A specific temporal relation in TemporalRelation CS is composed based on well-known Allen's 13 temporal relations. A specific spatial relation may be treated as a spatial analysis of a temporal relation. A specific interaction relation in Interaction CS is defined as one set of relative relations between components when the components are selectively consumed according to priorities.

The relation metadata allows describing a correlation between components. A basic concept of designing a schema describing relations is to allow an abstract description based on a compacted method while allowing an intended function. That is, there is no quantitative representation describing how many components are related when and/or where associated components are processed.

For example, if two components have a relation of “Precedes” as TemporalRelation, the relation represents that one component is located behind of another component in time domain. However, there is no time information provided to start next component. That is, there is no information how long the next component waits to be started. Such a shortcoming makes an application difficult to accurately operate a user interface or a scene according to user's intention when the application produces the user interface or the scene from a package in a personal digital recorder (PDR).

As mentioned above, the relations should include the quantitative representation accurately describing a total amount of relations while maintaining a schema compact by using small elements.

B. Quantitative Representation of TemporalRelation

As mentioned above, the temporal relation (TemporalRelation) should be described with an amount of time for a gap and an overlap between components. An absolute time is simply used for describing a time duration or an absolute time based on a reference time is used as another method for describing a time duration. Furthermore, the time duration may be described by increasing a basic time which is pre-defined for representing a relative location of component in a time domain. MPEG-7 MDS is information about the absolute time and is defined by using a MediaDuration as an absolute time and a MediaIncrDuration as relative time information.

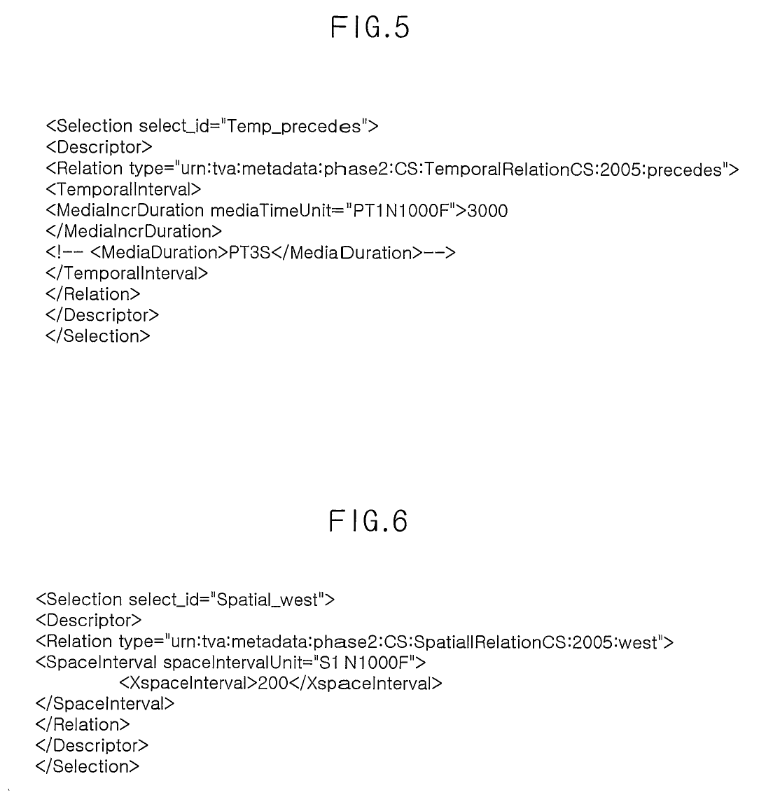

FIG. 5 shows an example of a temporal relation having a quantitative representation.

As shown in FIG. 5, a relation is a temporal relation (TemporalRelation) and it makes a time gap between components. By using MediaDuration and MediaIncrDuration, a total amount of time duration is described. The quantitative relation of relative time between components is defined as 3 second (SIN1000F).

C. Quantitative Representation of SpatialRelation

The spatial relation (SpatialRelation) should also be described with a total amount for a gap and an overlap in a spatial domain formed between components.

By using a pixel, the total amount can be simply described. For example, (5,0) represents that a component is 5 pixels apart from another component in an x-axis. However, such an absolute value is not appropriate for constructing a scalable scene, which may be used in a targeting service based on various terminal conditions. For example, if a total amount is (500, 0) when a package metadata produces a screen of 960×540, the package cannot be appropriately displayed at a personal digital assistant (PDA) having a 240×320 screen size.

Therefore, use of relative size based on an initial screen size is proposed in the present invention instead of using an absolute size. For example, (500, 0) may be re-described as (500/960, 0/540) or (0.521, 0). A rational number as a term for describing the total amount may be a percentage i.e., (521,0) or a permillage (52.1,0). A value of spatial gap in the PDA can be calculated as follows. That is, (240×521/1000), (320×0)=(125, 0).

FIG. 6 shows a spatial relation having a quantitative representation.

Referring to FIG. 6, a component has a spatial relation (SpatialRelation) of “west” and two components have a gap of 200 permil in an x-axis. Therefore, if the component is displayed at the PDA, one component is arranged at 48 pixels left from the other component (240×200/1000=48).

D. Refined Structure of Relation Metadata

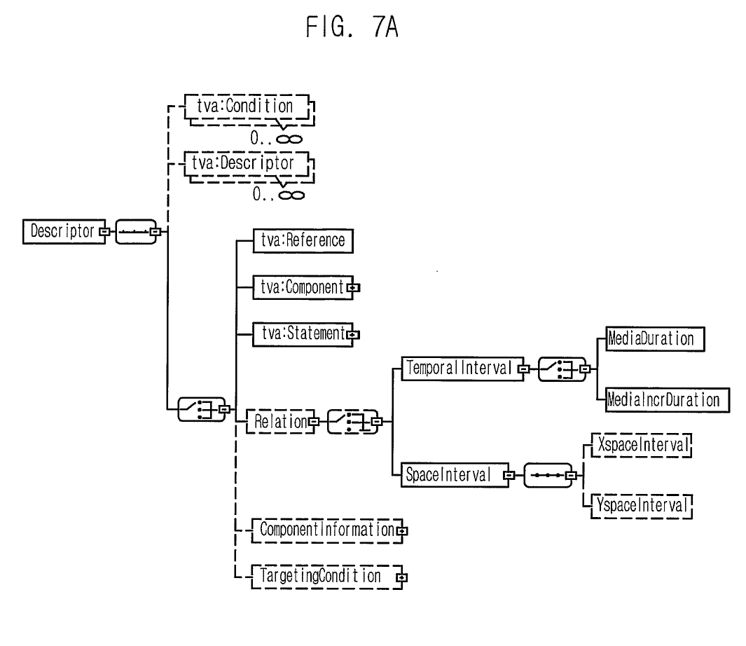

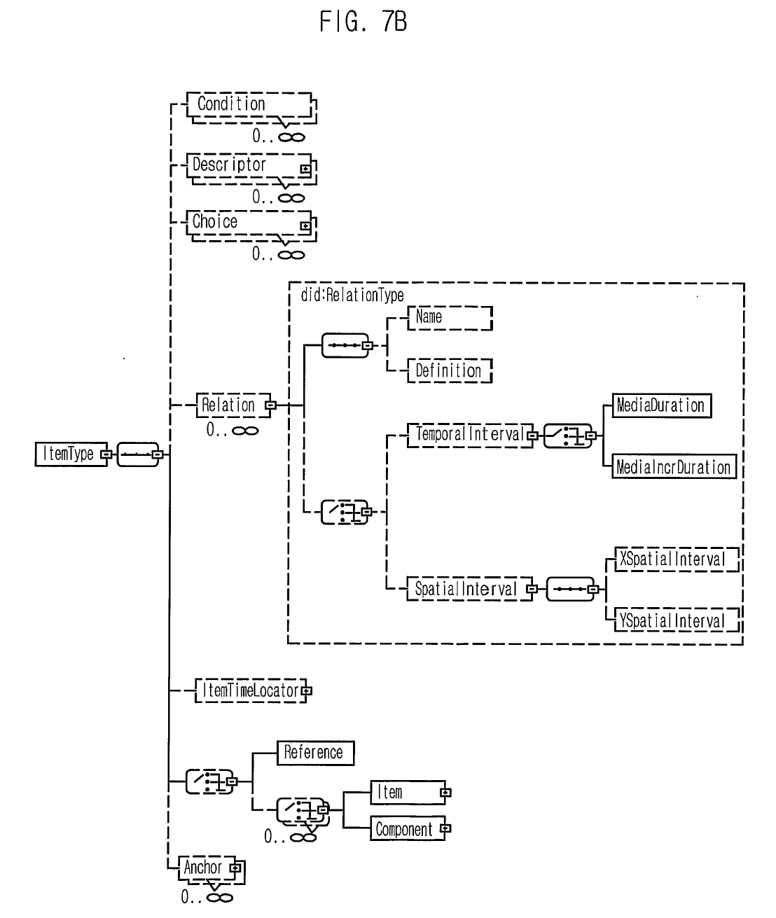

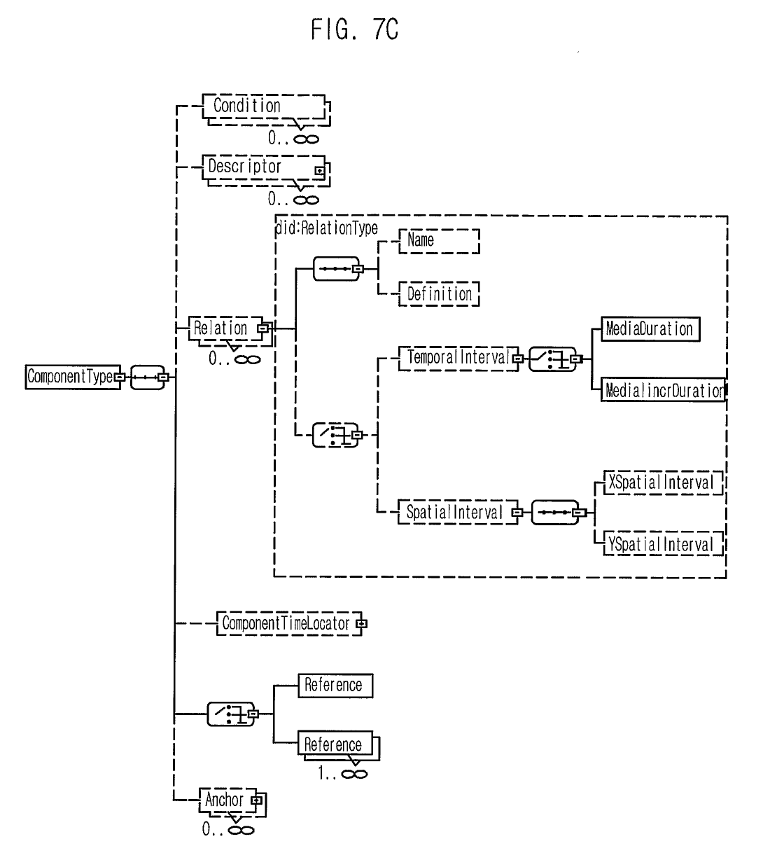

FIGS. 7A to 7C show a structure of relation metadata in accordance with a preferred embodiment of the present invention. FIG. 7A shows that a relation metadata is arranged below a descriptor, FIG. 7B shows that a relation metadata is arrange below an Item and FIG. 7C shows that a relation metadata is arranged below a component.

Referring to FIGS. 7A to 7C, a relation has two selective elements, i.e., a time interval (TemporalInterval) and a spatial interval (SpaceInterval). As described above, the TemporalInterval may be described by using the MediaDuration and the MediaIncrDuration. And, the SpaceInterval is described as a related size on an X-axis and a Y-axis based on an initial assumed screen size.

<Re-Define Interaction Relations (INTERACTIONRELATION CS)>

A representation of an interaction relation defining a set of relations shown in below table 1 is not suitable to semantics of defined terms. The relations are defined to be used for defining relative relation between components when the components are selectively consumed. In this view, the set of relations are described to use a Selection Relation instead of using the Interaction Relation.

TABLE 1

| Term | Relation description |
|---|---|
| And | Components must be provided for user experience |
| | at one time |
| Or | Components can be chosen among them |
| Optional | Components can be consumed or not by user |

<Example of a Package Having a Quantitative Relation>

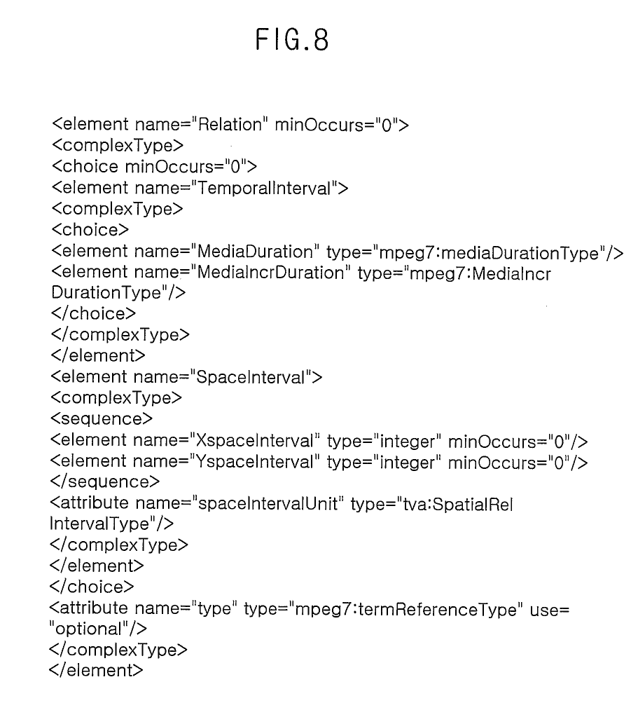

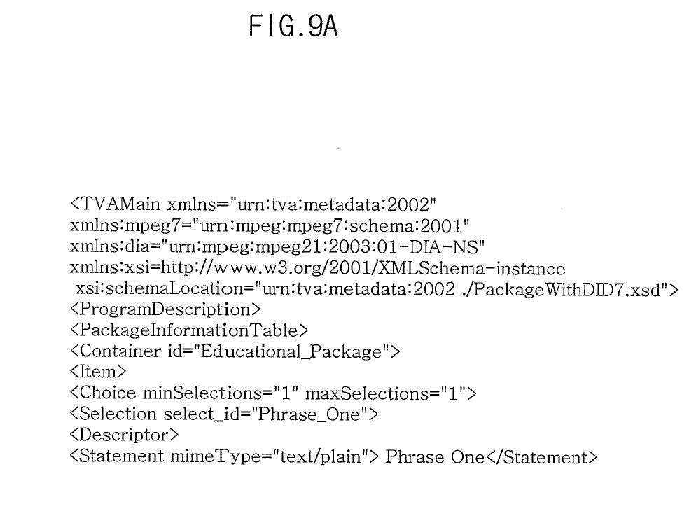

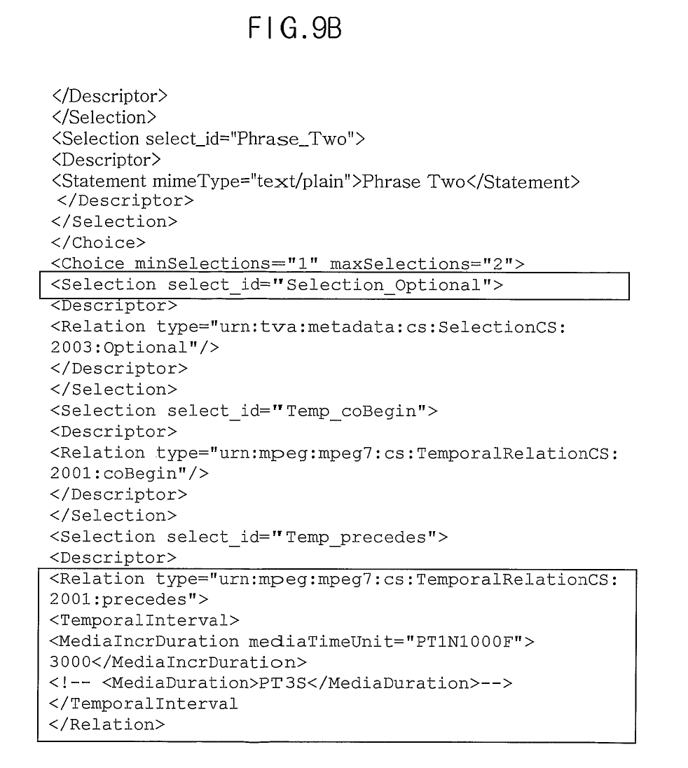

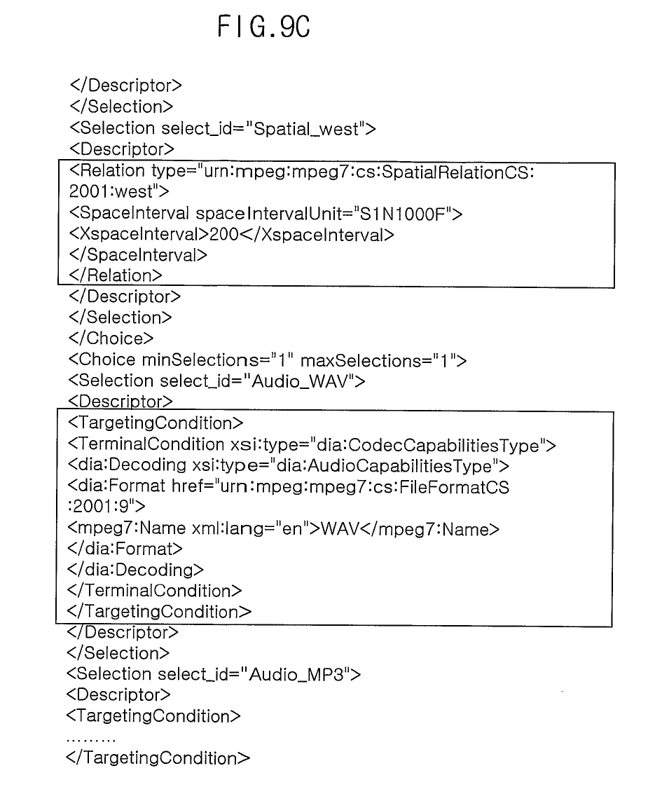

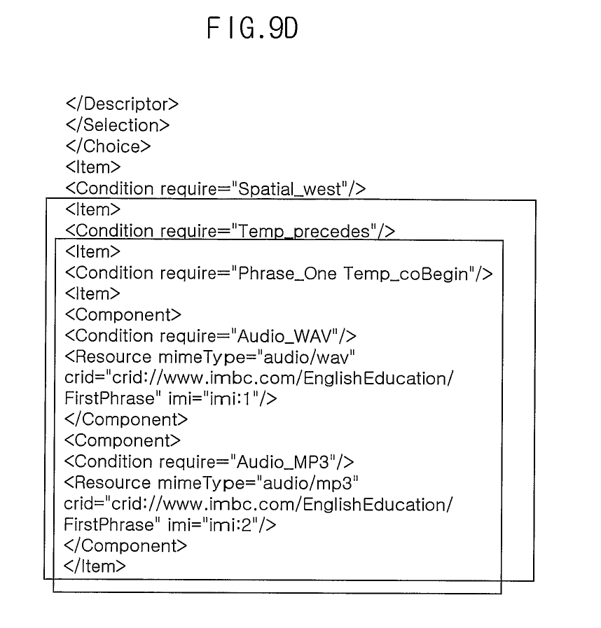

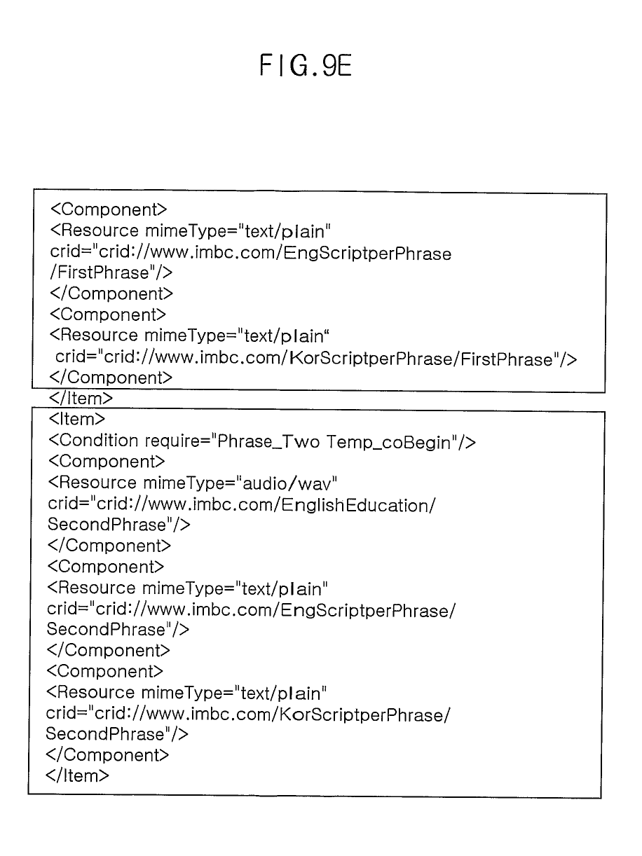

FIG. 8 show a relation metadata schema having a quantitative representation and FIGS. 9A to 9F show learning package metadata for provided relation schema. Various components and items have relations such as “precedes” as the temporal relation and “west” as the spatial relation. A value of the temporal relation “precedes” is 3 second and a value of the spatial relation “west” is 200/1000× as a screen width.

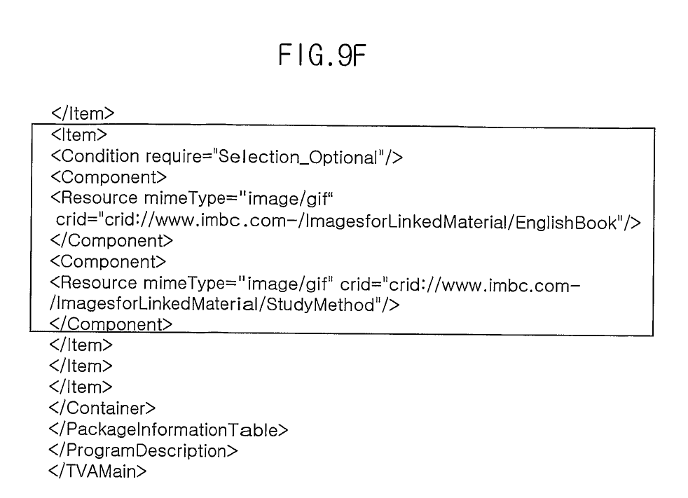

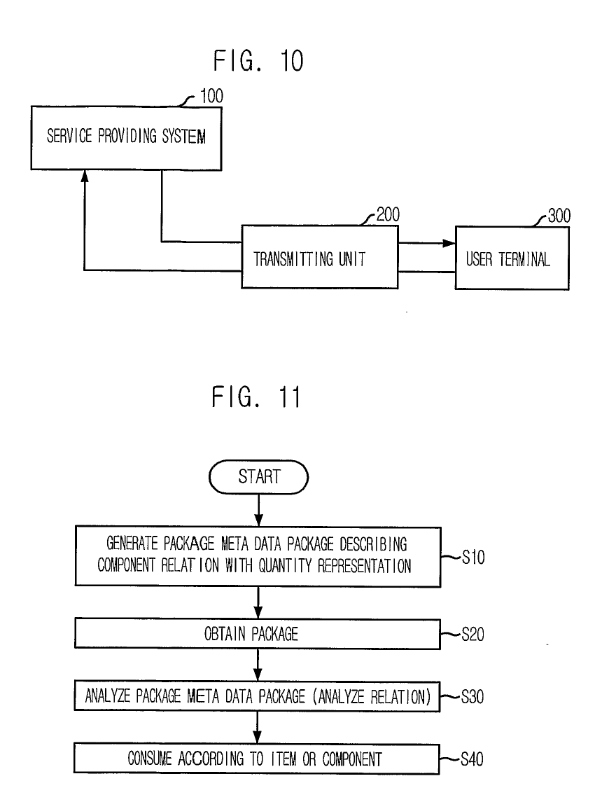

FIG. 10 is a diagram illustrating a TV-Anytime service system in accordance with a preferred embodiment.

Referring to FIG. 10, the TV-Anytime service system includes a service providing system 100 for providing various contents and package metadata; and a user terminal 300 for consuming the various contents and the package metadata provided from the service providing system 100. The various contents and the package metadata are provided through a transmitting unit 200 from the service providing system 100 to the user terminal 300. The transmitting unit 200 may be a broadcasting network, an Internet, a mobile communication terminal and a wireless local area network (WLAN) for the TV-Anytime service. The user terminal 300 may be a television (TV), a personal computer (PC), a handheld phone, a personal digital assistant (PDA) and a digital multimedia broadcasting (DMB) terminal.

Also, the service providing system 100 may be described as “TV-Anytime domain side” and the user terminal 300 may be described as “TV-Anytime box side” or “client (PDR/NDR) side”.

There may be various embodiments of the present invention without departing from the scope of the present invention and the service providing system 100 may include: a temporal relation describing unit for describing a temporal relation having a quantitative representation for describing a time order of consuming components; a spatial relation describing unit for describing a spatial relation for describing a relative location of a component in a user interface; and a package metadata generating unit for generating a package metadata using the temporal relation describing unit and the spatial relation describing unit. The user terminal may also include: a package metadata obtaining unit for obtaining a package metadata; and a relation analyzing unit for analyzing a relation with a quantitative representation between components in the obtained package metadata.

FIG. 11 is a flowchart showing a TV-Anytime service method in accordance with a preferred embodiment.

Referring to FIGS. 10 and 11, the service providing system 100 generates a package metadata describing component relations with the quantitative representations at step S10. The package metadata describing component relations with the quantitative representations includes data for the temporal interval and the space interval as described above. The user terminal 300 obtains the package metadata for obtaining a desired package at step S20. If the user terminal 300 obtains the desired package, the user terminal 300 analyzes the package metadata at step S30 for detecting the component relation. After detecting the component relation, the user terminal 300 consumes components or items according to the detected component relation.

While the present invention has been described with respect to certain preferred embodiments, it will be apparent to those skilled in the art that various changes and modifications may be made without departing from the scope of the invention as defined in the following claims.

Advantageous Effects

Three classifications of a relation, i.e., a temporal relation, a spatial relation and an interaction relation have been defined for specifying a relative relation between components in an abstraction level by considering a targeting and a synchronization application. In the present invention, a refined schema of the relation is proposed to describe a total amount of a spatial relation and a temporal relation.

Accordingly, the proposed relation schema enables a PDR application to accurately perform a user interface or a scene according to a user's intention when the user interface or the scene is constructed from a package. An example of the relation schema may be employed to support a learning scenario.

### MODE FOR THE INVENTION

The above and other objects, features, and advantages of the present invention will become apparent from the following description and thereby one of ordinary skill in the art can embody the technological concept of the present invention easily. In addition, if further detailed description on the related prior art is determined to blur the point of the present invention, the description is omitted. Hereafter, preferred embodiments of the present invention will be described in detail with reference to the drawings. The terms or words used in the claims of the present specification should not be construed to be limited to conventional meanings and meanings in dictionaries and the inventor(s) can define a concept of a term appropriately to describe the invention in the best manner. Therefore, the terms and words should be construed in the meaning and concept that coincide with the technological concept of the present invention.

In claims of the present invention, constituent elements described as means for performing functions described in the present specification may include, for example, combinations of circuits for performing the functions or all methods including all types of software having a firmware/micro codes for performing the functions. Also, the constituent element may be coupled to an appropriate circuit for performing the software in order to perform the functions. Therefore, any means providing the functions should be understood to be equivalent to present embodiments represented in the present specification because the present invention defined by the claims includes combined functions provided from various described means and they are combined based on a method required by the claims.

In the present specification of the present invention, a term of “selection relation” is used as a term of “interaction relation”. Therefore, there are three terms such as a temporal relation, a spatial relation and a selection relation allowed for describing an interaction relation between components.

Hereinafter, a relation metadata will be explained at first and then a component relation model with a quantitative representation and a structure of a conscious package with enhanced relation description will be explained.

The relation metadata is information describing a relation between items or components for formation and synchronization between components.

In order to describe the relation metadata, the metadata relation between the component and the item will be explained at first.

Referring to classification schemes (CS), various relations between components can be described by using terms of a temporal, a spatial and an interaction in a component model. The components are also employed to items of a package. In the present embodiment, a selection relation is used as the interaction relation.

The relations between defined components, between items, and between components and items are used to represent how the components, items, or components and items are consumed in an abstract level rather than to represent precise synchronization which requires entire scene description such as SMIL, XMT-0 and BIFS simply by using terms pre-defined in the CS.

At first, a temporal relation (TemporalRelation CS) will be explained.

FIG. 2 is a table showing binary temporal relations and FIG. 3 is a table describing n-ary temporal relations. As shown in FIGS. 2 and 3, names of relations and names of inverse relations mathematically inversed from the relations are described in fields of “Relation Name” and “Inverse Relation”, respectively. Also, properties of corresponding relations and examples of using corresponding relations are described in fields of “Properties” and “Examples”, respectively.

A spatial relation (SpatialRelation CS) will be explained hereinafter.

FIGS. 4A and 4B show definitions of spatial relations (SpatialRelation CS).

In FIGS. 4A and 4B, names of relations and inverse relations are described in fields of “Relation Name” and “Inverse Relation”, respectively and mathematical definitions of corresponding relations are described in a field of “Definition”. Additionally, properties are described in the field of “Properties” and examples of corresponding relation are also described in the field of “Informative Examples”. Relations from “south” to “over” are based on a spatial relation. Relations from “equals” to “separated” are relations added in a base relation (BaseRelation). The spatial CS (SpatialCS) may be substituted by the spatial relation CS (SpatialRelation CS) in one-to-one manner and may be expanded by additional necessity.

<Enhancement of Relation Representation Having Quantitative Terms>

A. Necessity of Quantitative Representation

The relation metadata was explained as described above. The relation metadata allows describing a relative relation of three types, i.e., a temporal relation (TemporalRelation), a spatial relation (SpatialRelation) and a selectional relation (SelectionRelation) by referring to corresponding classification schemes between components (SCs).

A specific temporal relation in TemporalRelation CS is composed based on well-known Allen's 13 temporal relations. A specific spatial relation may be treated as a spatial analysis of a temporal relation. A specific interaction relation in Interaction CS is defined as one set of relative relations between components when the components are selectively consumed according to priorities.

The relation metadata allows describing a correlation between components. A basic concept of designing a schema describing relations is to allow an abstract description based on a compacted method while allowing an intended function. That is, there is no quantitative representation describing how many components are related when and/or where associated components are processed.

For example, if two components have a relation of “Precedes” as TemporalRelation, the relation represents that one component is located behind of another component in time domain. However, there is no time information provided to start next component. That is, there is no information how long the next component waits to be started. Such a shortcoming makes an application difficult to accurately operate a user interface or a scene according to user's intention when the application produces the user interface or the scene from a package in a personal digital recorder (PDR).

As mentioned above, the relations should include the quantitative representation accurately describing a total amount of relations while maintaining a schema compact by using small elements.

B. Quantitative Representation of TemporalRelation

As mentioned above, the temporal relation (TemporalRelation) should be described with an amount of time for a gap and an overlap between components. An absolute time is simply used for describing a time duration or an absolute time based on a reference time is used as another method for describing a time duration. Furthermore, the time duration may be described by increasing a basic time which is pre-defined for representing a relative location of component in a time domain. MPEG-7 MDS is information about the absolute time and is defined by using a MediaDuration as an absolute time and a MediaIncrDuration as relative time information.

FIG. 5 shows an example of a temporal relation having a quantitative representation.

As shown in FIG. 5, a relation is a temporal relation (TemporalRelation) and it makes a time gap between components. By using MediaDuration and MediaIncrDuration, a total amount of time duration is described. The quantitative relation of relative time between components is defined as 3 second (SIN1000F).

C. Quantitative Representation of SpatialRelation

The spatial relation (SpatialRelation) should also be described with a total amount for a gap and an overlap in a spatial domain formed between components.

By using a pixel, the total amount can be simply described. For example, (5,0) represents that a component is 5 pixels apart from another component in an x-axis. However, such an absolute value is not appropriate for constructing a scalable scene, which may be used in a targeting service based on various terminal conditions. For example, if a total amount is (500, 0) when a package metadata produces a screen of 960×540, the package cannot be appropriately displayed at a personal digital assistant (PDA) having a 240×320 screen size.

Therefore, use of relative size based on an initial screen size is proposed in the present invention instead of using an absolute size. For example, (500, 0) may be re-described as (500/960, 0/540) or (0.521, 0). A rational number as a term for describing the total amount may be a percentage i.e., (521,0) or a permillage (52.1,0). A value of spatial gap in the PDA can be calculated as follows. That is, (240×521/1000), (320×0)=(125, 0).

FIG. 6 shows a spatial relation having a quantitative representation.

Referring to FIG. 6, a component has a spatial relation (SpatialRelation) of “west” and two components have a gap of 200 permil in an x-axis. Therefore, if the component is displayed at the PDA, one component is arranged at 48 pixels left from the other component (240×200/1000=48).

D. Refined Structure of Relation Metadata

FIGS. 7A to 7C show a structure off relation metadata in accordance with a preferred embodiment of the present invention. FIG. 7A shows that a relation metadata is arranged below a descriptor, FIG. 7B shows that a relation metadata is arrange below an Item and FIG. 7C shows that a relation metadata is arranged below a component.

Referring to FIGS. 7A to 7C, a relation has two selective elements, i.e., a time interval (TemporalInterval) and a spatial interval (SpaceInterval). As described above, the TemporalInterval may be described by using the MediaDuration and the MediaIncrDuration. And, the SpaceInterval is described as a related size on an X-axis and a Y-axis based on an initial assumed screen size.

<Re-Define Interaction Relations (INTERACTIONRELATION CS)>

A representation of an interaction relation defining a set of relations shown in below table 1 is not suitable to semantics of defined terms. The relations are defined to be used for defining relative relation between components when the components are selectively consumed. In this view, the set of relations are described to use a Selection Relation instead of using the Interaction Relation.

TABLE 1

| Term | Relation description |
|---|---|
| And | Components must be provided for user experience |
| | at one time |
| Or | Components can be chosen among them |
| Optional | Components can be consumed or not by user |

<Example of a Package Having a Quantitative Relation>

FIG. 8 show a relation metadata schema having a quantitative representation and FIGS. 9A to 9F show learning package metadata for provided relation schema. Various components and items have relations such as “precedes” as the temporal relation and “west” as the spatial relation. A value of the temporal relation “precedes” is 3 second and a value of the spatial relation “west” is 200/1000× as a screen width.

FIG. 10 is a diagram illustrating a TV-Anytime service system in accordance with a preferred embodiment.

Referring to FIG. 10, the TV-Anytime service system includes a service providing system 100 for providing various contents and package metadata; and a user terminal 300 for consuming the various contents and the package metadata provided from the service providing system 100. The various contents and the package metadata are provided through a transmitting unit 200 from the service providing system 100 to the user terminal 300. The transmitting unit 200 may be a broadcasting network, an Internet, a mobile communication terminal and a wireless local area network (WLAN) for the TV-Anytime service. The user terminal 300 may be a television (TV), a personal computer (PC), a handheld phone, a personal digital assistant (PDA) and a digital multimedia broadcasting (DMB) terminal.

Also, the service providing system 100 may be described as “TV-Anytime domain side” and the user terminal 300 may be described as “TV-Anytime box side” or “client (PDR/NDR) side”.

There may be various embodiments of the present invention without departing from the scope of the present invention and the service providing system 100 may include: a temporal relation describing unit for describing a temporal relation having a quantitative representation for describing a time order of consuming components; a spatial relation describing unit for describing a spatial relation for describing a relative location of a component in a user interface; and a package metadata generating unit for generating a package metadata using the temporal relation describing unit and the spatial relation describing unit. The user terminal may also include: a package metadata obtaining unit for obtaining a package metadata; and a relation analyzing unit for analyzing a relation with a quantitative representation between components in the obtained package metadata.

FIG. 11 is a flowchart showing a TV-Anytime service method in accordance with a preferred embodiment.

Referring to FIGS. 10 and 11, the service providing system 100 generates a package metadata describing component relations with the quantitative representations at step S10. The package metadata describing component relations with the quantitative representations includes data for the temporal interval and the space interval as described above. The user terminal 300 obtains the package metadata for obtaining a desired package at step S20. If the user terminal 300 obtains the desired package, the user terminal 300 analyzes the package metadata at step S30 for detecting the component relation. After detecting the component relation, the user terminal 300 consumes components or items according to the detected component relation.

Three classifications of a relation, i.e., a temporal relation, a spatial relation and an interaction relation have been defined for specifying a relative relation between components in an abstraction level by considering a targeting and a synchronization application. In the present invention, a refined schema of the relation is proposed to describe a total amount of a spatial relation and a temporal relation.

Accordingly, the proposed relation schema enables a PDR application to accurately perform a user interface or a scene according to a user's intention when the user interface or the scene is constructed from a package. An example of the relation schema may be employed to support a learning scenario.

The present application contains subject matter related to Korean patent application No. 2003-______, filed in the Korean Intellectual Property Office on Oct. 2, 2003, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A TV-Anytime service system employing an enhanced model of relation with a quantitative representation, the TV-Anytime service system comprising a service providing device, wherein the service providing device includes:
a temporal relation describing means for describing a temporal relation having a quantitative representation for describing a time order of consuming components;
a spatial relation describing means for describing a spatial relation for describing a relative location of a component in a user interface; and
a package metadata generating means for generating a package metadata using the temporal relation describing means and the spatial relation describing means.

2. The TV-Anytime service system as recited in claim 1, wherein the temporal relation having the quantitative representation includes at least one of absolute time information or relative time information for the time order of consuming the components.

3. The TV-Anytime service system as recited in claim 1, wherein the temporal relation having the quantitative representation includes relative size information according to a user interface.

4. A TV-Anytime service system employing an enhanced model of relation with a quantitative representation, the TV-Anytime service system comprising a user terminal, wherein the user terminal includes:
a package metadata obtaining means for obtaining a package metadata; and
a relation analyzing means for analyzing a relation with a quantitative representation between components in the obtained package metadata.

5. The TV-Anytime service system as recited in claim 4, wherein the relation with the quantitative representation includes at least one of absolute time information and relative time information for a consuming order.

6. The TV-Anytime service system as recited in claim 4, wherein the relation with the quantitative representation includes relative size information according to a user interface.

7. A TV-Anytime service system employing an enhanced quantitative representation, the TV-Anytime service system is characterized to use a temporal relation metadata having a quantitative representation for describing a time order of consuming components and a spatial relation metadata for describing a related location of a user interface.

8. A TV-Anytime service system employing an enhanced quantitative representation, comprising:
a service providing device for generating a package metadata describing component relations with a quantitative representation; and
a user terminal for consuming components according to analysis of the component relations with the quantitative representation in the generated package metadata.

9. A TV-Anytime service method employing an enhanced model of relation with a quantitative representation, the TV-Anytime service method comprising the steps of:
generating a package metadata describing component relations with a quantitative representation;
analyzing the component relation with the quantitative representation by obtaining the package metadata; and
consuming components according to analysis of the component relation with the quantitative representation.

10. The TV-Anytime service method as recited in claim 9, wherein the quantitative representation includes:
a temporal relation having a quantitative representation for describing a time order of consuming components; and
a spatial relation having a quantitative representation for describing a related location of a component on a user interface.

11. The TV-Anytime service method as recited in claim 10, wherein the temporal relation having the quantitative representation includes at least one of absolute time information and relative time information for the time order of consuming the components.

12. The TV-Anytime service method as recited in claim 10, wherein the spatial relation having the quantitative representation includes relative size information according to the user interface.
